(19) United States
(12) Patent Application Publication
(10) Pub. No.: US 2014/0134870 A1
(43) Pub. Date: May 15, 2014

(54) CONNECTOR ASSEMBLY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHAN-YANG LI, Shenzhen (CN); CHONG DUAN, Shenzhen (CN)

(21) Appl. No.: 13/931,531

(22) Filed: Jun. 28, 2013

(30) Foreign Application Priority Data
Nov. 15, 2012 (CN) 2012104593755

(51) Int. Cl. H01R 13/627

(52) U.S. Cl. CPC H01R 13/6272
USPC 439/350

(57) ABSTRACT

A connector assembly includes a first connector and a second connector. The first connector includes a first connector main body and a clipping member connected to the first connector main body. The clipping member comprises a deformable extending panel and a clipping portion is located on the extending panel. The second connector comprising a second connector main body engages with the first connector main body. An engaging portion is located on the second connector. The clipping portion is engaged with the engaging portion.

### BACKGROUND

1. Technical Field

The present disclosure relates to electronic devices, more particularly to a connector assembly.

2. Description of Related Art

Connectors are used to electronically connect a first object to a second object. The connector includes a contact, a terminal, an interface, and other conductors. For example, a first connector is connected to a second connector via a cable, and the second connector is connected to a circuit board to electronically couple the first connector with the circuit board. However, the first connector is often unstably connected to the second connector, so it is easy for the first connector to be disengaged from the second connector. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a connector assembly in accordance with an embodiment.

FIG. 2 is an assembled view of the connector assembly of FIG. 1.

FIG. 3 is a cross-sectional view of the connector assembly of FIG. 3, taken along a line III-III.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

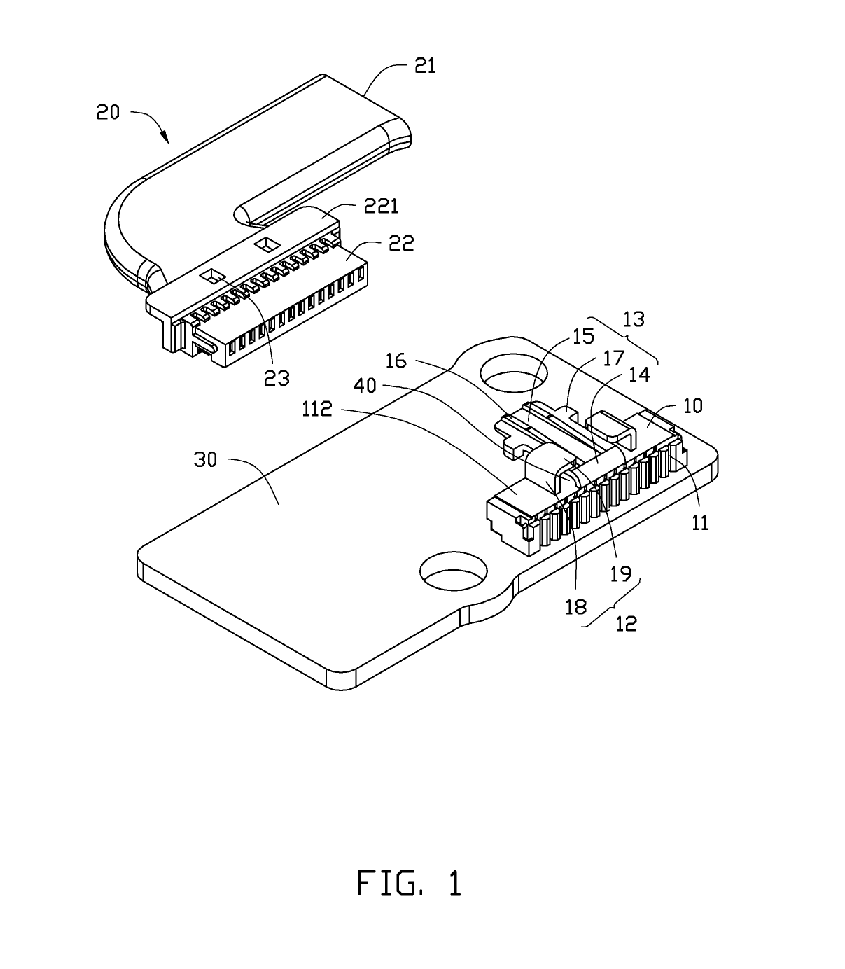

FIG. 1 illustrates a connector assembly in accordance with an embodiment. The connector assembly comprises a circuit board 30, a first connector 10 attached to the circuit board 30, and a second connector 20 configured to be attached to the first connector 10.

The first connector 10 comprises a first connector main body 11, two limiting pieces 12, and a clipping member 13 located between the two limiting pieces 12. The first connector main body 11 comprises a first top surface 112. Each of the two limiting pieces 12 extends from the first top surface 112. The clipping member 13 extends from an edge of the first top surface 112. A gap 40 is defined between the first top surface 112 and the clipping member 13, so that the clipping member 13 is deformable in a direction that is substantially perpendicular to the first top surface 112.

The clipping member 13 comprises a connecting portion 14 extending from the top surface 112, an extending panel 15 extending from the connecting portion 14, and two clipping portions 17 extending downward from opposite edges of the extending panel 15. Each of the two clipping portions 17 is substantially perpendicular to the extending panel 15. In one embodiment, the extending panel 15 is substantially parallel to the circuit board 30, and the connecting portion 14 is substantially arcuate. Two strengthening ribs 16 protrude from a top surface of the extending panel 15.

Each of the two limiting pieces 12 are used to prevent the clipping member 13 from moving away from the top surface 112 and comprises a linking portion 18 and a limiting portion 19 connected to the linking portion 18. In one embodiment, the linking portion 18 is substantially perpendicular to the limiting portion 19 and the first top surface 112.

The second connector 20 comprises a cable 21 and a second connector main body 22 connected to the cable 21. A securing panel 221 extends from the second connector main body 22 towards the cable 21. The securing panel 221 comprises two engaging portions, such as clipping holes 23.

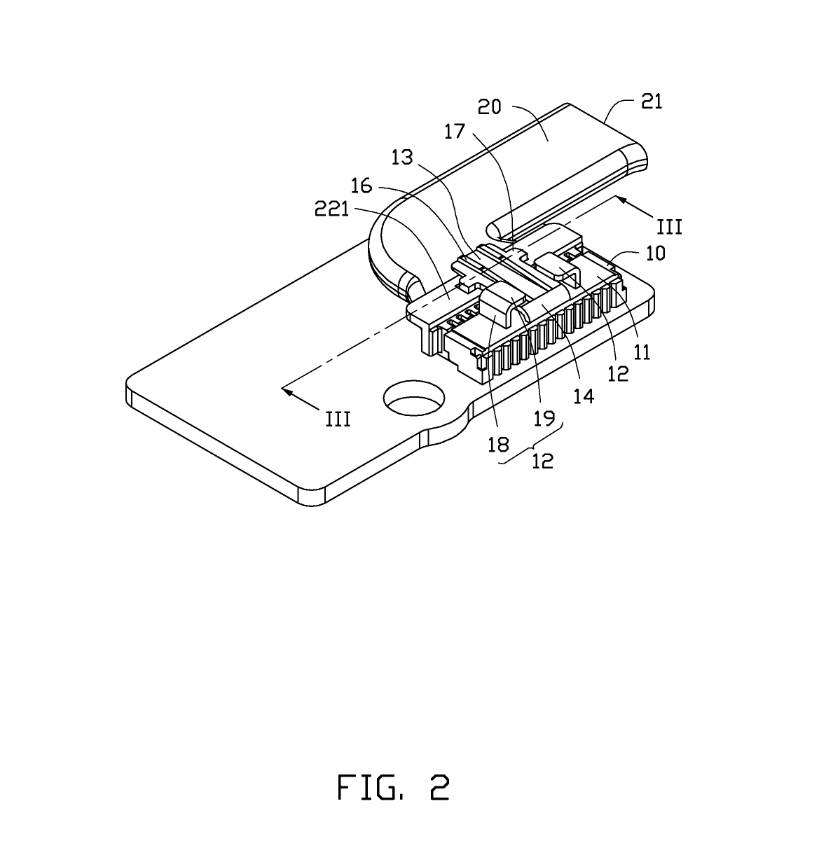

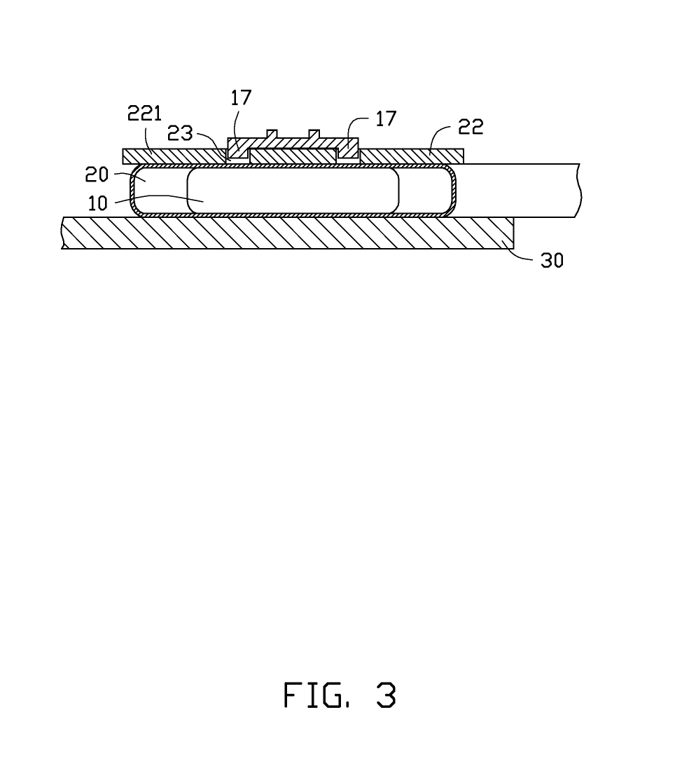

FIGS. 2-3 show in assembly, the second connector main body 22 is aligned with the first connector main body 11. The clipping member 13 is deformed away from the top surface 112, until the securing panel 221 can be inserted into between the clipping member 13 and the circuit board 30. When the second connector main body 22 is engaged with the first connector main body 11, the two clipping holes 23 are aligned with the two clipping portions 17. The clipping member 13 is released to turn towards the top surface 112 and to engage the two clipping portions 17 into the two clipping holes 23 for preventing the second connector 20 from disengaging from the first connector 10. Thus, the second connector 20 is secured to the first connector 10.

In disassembly, the clipping member 13 is deformed away from the top surface 112 to disengage the clipping portions 17 from the two clipping holes 23. The second connector main body 22 is disengaged from the first connector main body 11. Therefore, the second connector 20 is detached away from the first connector 10.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A connector assembly comprising:
a first connector comprising a first connector main body and a clipping member connected to the first connector main body; and the clipping member comprising an extending panel extending from the first connector main body and a clipping portion located on the extending panel; and
a second connector comprising a second connector main body; an engaging portion located on the second connector;
wherein when the second connector main body is engaged with the first connector main body, and the extending panel is engaged the clipping portion into the clipping portion.

2. The connector assembly of claim 1, wherein the first connector main body comprises a top surface, and the extending panel is substantially parallel to the top surface.

3. The connector assembly of claim 2, wherein the extending panel is deformable in a direction, which is substantially perpendicular to the top surface.

4. The connector assembly of claim 2, wherein the clipping member further comprises a connecting portion connected to the extending panel, and the connecting portion extends from the top surface.

5. The connector assembly of claim 2, wherein the first connector further comprises two limiting pieces, the clipping member is located between the two limiting pieces, and the two limiting pieces are adapted to prevent the clipping member from moving away from the top surface.

6. The connector assembly of claim 5, wherein each of the two limiting pieces comprises a linking portion and a limiting portion connected to the linking portion, and the linking portion is substantially perpendicular to the limiting portion and the top surface.

7. The connector assembly of claim 1, wherein a securing panel extends from the second connector main body, the engaging portion is a clipping hole, and the clipping hole is defined in the securing panel.

8. The connector assembly of claim 1, wherein the clipping portion is substantially perpendicular to the extending panel.

9. A connector assembly comprising:
a first connector comprising a first connector main body and a clipping member; the first connector main body comprising a top surface; the clipping member comprising an extending panel extending from the first connector main body and substantially parallel to the top surface; a clipping portion located on the extending panel; and
a second connector comprising a second connector main body engaged with the first connector main body; an engaging portion defined in the second connector; the clipping portion clipped with the engaging portion;
wherein the extending panel is deformable to disengage the clipping portion from the engaging portion.

10. The connector assembly of claim 9, wherein the extending panel is deformable in a direction that is substantially perpendicular to the top surface.

11. The connector assembly of claim 9, wherein the clipping member further comprises a connecting portion connected to the extending panel, and the connecting portion extends from an edge of the top surface.

12. The connector assembly of claim 9, wherein the first connector further comprises two limiting pieces, the clipping member is located between the two limiting pieces, and the two limiting pieces are adapted to prevent the clipping member from moving away from the top surface.

13. The connector assembly of claim 12, wherein each of the two limiting pieces comprises a linking portion and a limiting portion connected to the linking portion, and the linking portion is substantially perpendicular to the limiting portion and the top surface.

14. The connector assembly of claim 9, wherein the clipping portion extends from a side edge of the extending panel.

15. The connector assembly of claim 9, wherein a securing panel extends from the second connector main body, the engaging portion is a clipping hole, and the clipping hole is defined in the securing panel.

16. The connector assembly of claim 9, wherein the clipping portion is substantially perpendicular to the extending panel.
